(19) United States
(12) Patent Application Publication
(10) Pub. No.: US 2005/0030430 A1
(43) Pub. Date: Feb. 10, 2005

(54) Video signal processing circuit

(75) Inventor: Hiroshi Matsui, Oota (JP)

Correspondence Address: HOGAN & HARTSON L.L.P., 500 S. GRAND AVENUE, SUITE 1900, LOS ANGELES, CA, 90071-2611, US

(73) Assignee: SANYO ELECTRIC CO., LTD.

(21) Appl. No.: 10/911,892

(22) Filed: Aug. 5, 2004

(30) Foreign Application Priority Data
Aug. 7, 2003 (JP) 2003-288403

(51) Int. Cl. H04N 5/52; H04N 5/14

(52) U.S. Cl. 348/673; 348/678

(57) ABSTRACT

A video signal processing circuit comprises a luminance detector circuit for detecting the luminance of a video signal that is input and a contrast adjustment circuit for changing the contrast ratio of each chrominance signal in accordance with a detection result of the luminance detector circuit. As a result, when the luminance is low, for example, the contrast ratio can be increased in accordance with the luminance so that a clearer video image can be obtained.

### CROSS-REFERENCE TO RELATED APPLICATION(S)

The entire disclosure of Japanese Application No. 2003-288403 including specification, claims, drawings and abstract is incorporated herein by reference in its entirety.

### BACKGROUND OF THE INVENTION

1. Field of the Invention

The present invention relates to a video signal processing circuit for acquiring various chrominance signals from a video signal (composite video signal).

2. Description of the Related Art

If the contrast ratio of a display device is low, the shadow detail in dark video images is often lost. For example, in the case of a liquid crystal display, the contrast ratio is lower compared to a CRT display so that the shadow detail in dark video images is often lost.

It should be noted that various types of conventional video signal processing circuits are known. For example, a circuit, disclosed in the Apr. 10, 1989 edition of NHK Television Technology, Volume 1 by the Japan Broadcasting Corporation, acquires and processes various chrominance signals from a composite video signal.

To further improve the clarity of dark video images that are output to the display device, the contrast ratio should be increased. This is also an effective method for liquid crystal displays.

However, when an adjustment to increase the contrast ratio is performed to improve the clarity of dark video images, highlight details are lost at that contrast ratio and unclear images may result.

### SUMMARY OF THE INVENTION

A video signal processing circuit relating to the present invention comprises a luminance detector circuit for detecting the luminance of an input video signal, and a contrast adjustment circuit for varying the contrast ratio of each chrominance signal in accordance with a detection result of the luminance detector circuit. If the luminance is low, for example, the contrast adjustment circuit increases the contrast ratio in accordance with the luminance. This enables a clearer video image to be obtained.

### BRIEF DESCRIPTION OF THE DRAWINGS

FIG. 1 is a block diagram showing an example configuration of a video signal processing circuit relating to an embodiment of the present invention.

FIG. 2 shows an example configuration of a luminance detector circuit relating to the embodiment of the present invention.

FIG. 3 shows an example configuration of a contrast ratio adjustment circuit relating to the embodiment of the present invention.

FIG. 4 shows an example setting of a correlation between the contrast ratio (amplifier gain of each chrominance signal) and luminance based on the contrast ratio adjustment circuit of FIG. 3.

### DETAILED DESCRIPTION OF THE PREFERRED EMBODIMENTS

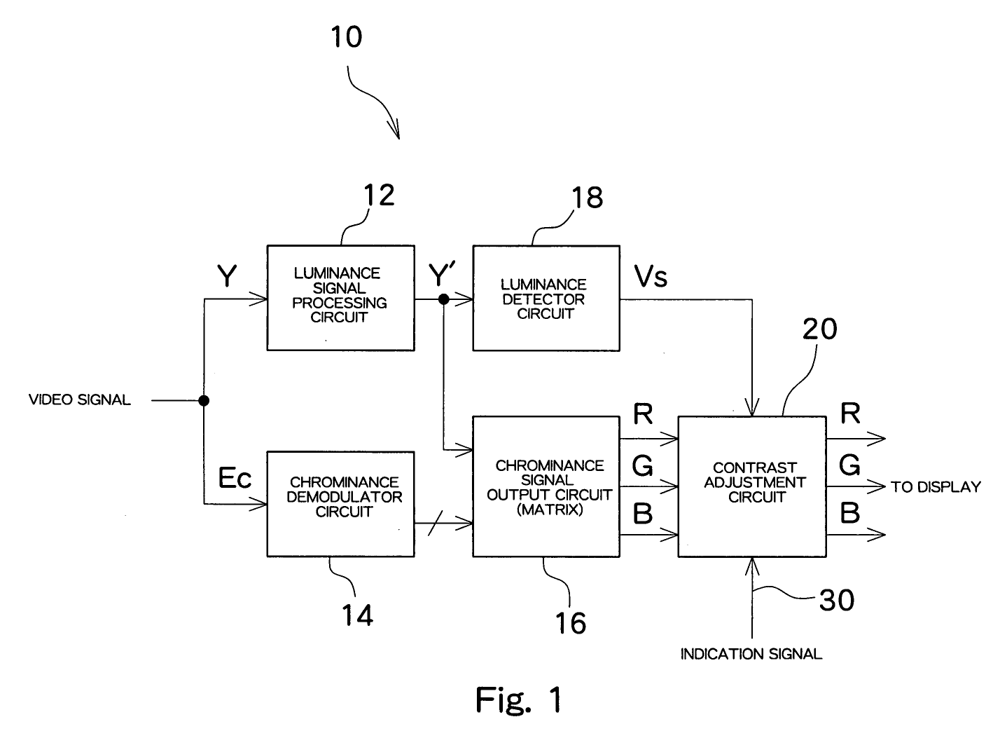

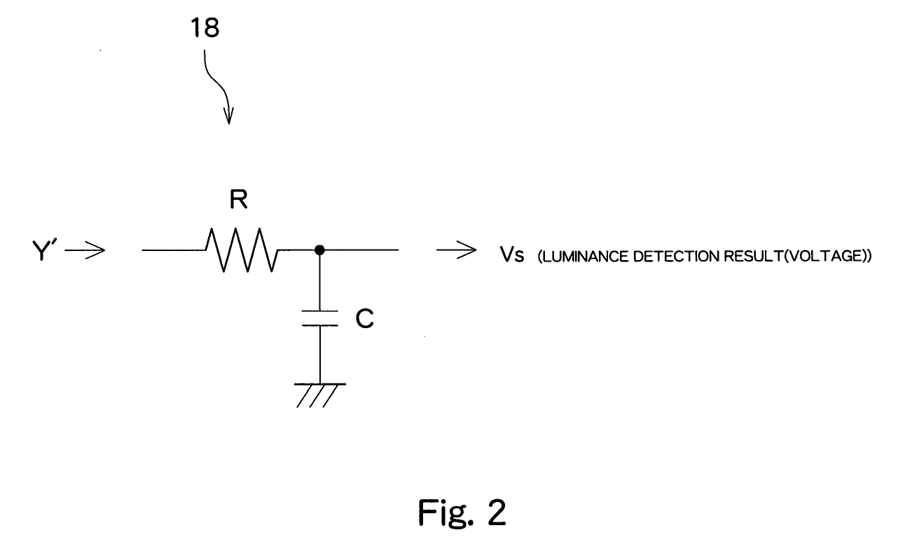

A preferred embodiment of the present invention will be described hereinafter with reference to the attached drawings. FIG. 1 is a block diagram of a video signal processing circuit 10 relating to the embodiment of the present invention and FIG. 2 is a diagram showing a specific example of a luminance detector circuit 18.

A luminance signal processing circuit 12 is a known circuit for performing a predetermined process (for example, amplification, filtering, etc.) for a luminance signal (Y) separated from a video signal (composite video signal).

A chrominance demodulator circuit 14 obtains color-difference signals (E_{R}-E_{Y}, E_{G}-E_{Y}, E_{B}-E_{Y}) from a carrier chrominance signal (E_{C}) that was separated from the video signal. The chrominance demodulator circuit 14 is also a known circuit, and such circuits based on dual-axis and three-axis demodulation systems are known.

A chrominance signal output circuit 16 combines the color-difference signals obtained by the chrominance demodulator circuit 14 and the luminance signal obtained by the luminance signal processing circuit 12, and is a known matrix circuit for obtaining the various chrominance signals (primary color signals: R, G, B).

The luminance detector circuit 18 detects the luminance of the input video signal. In the example of FIG. 1, the luminance detector circuit 18 obtains an average value (or integral value) during a predetermined detection period (this period will be referred to hereinafter as the detection period) for the luminance signal (Y′) that is output from the luminance signal processing circuit 12.

Then, as shown in FIG. 2, the luminance detector circuit 18 is configured, for example, with a resistance R and capacitance C, namely, as an RC filter (low-pass filter). In this case, the DC component (average value or integral value) of the luminance signal (Y′) during the detection period becomes the detection result (voltage).

It should be noted that the time constant in the example given in FIG. 2, namely, the above-mentioned detection period, is determined by the capacitor C. Therefore, if the video signal processing circuit 10 is to be configured as a single device (such as an IC), the detection period can be variably set in a relatively easy manner by using an externally connected capacitor, for example, for the capacitance C, and replacing it as necessary with a different capacitance.

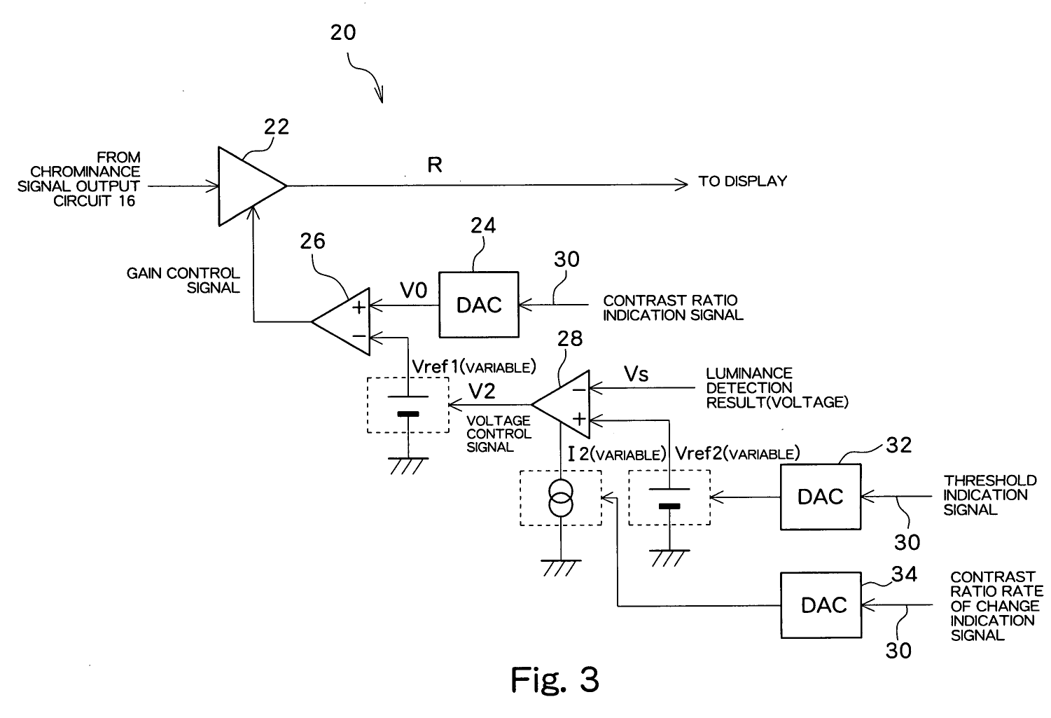

A contrast adjustment circuit 20 comprises an amplifier 22 as shown in FIG. 3, and performs an adjustment of the contrast ratio by controlling the gain of each chrominance signal (R, G, B) that is output from the chrominance signal output circuit 16. If the gain of the amplifier 22 is high, the contrast ratio increases, and if it is low, the contrast ratio decreases.

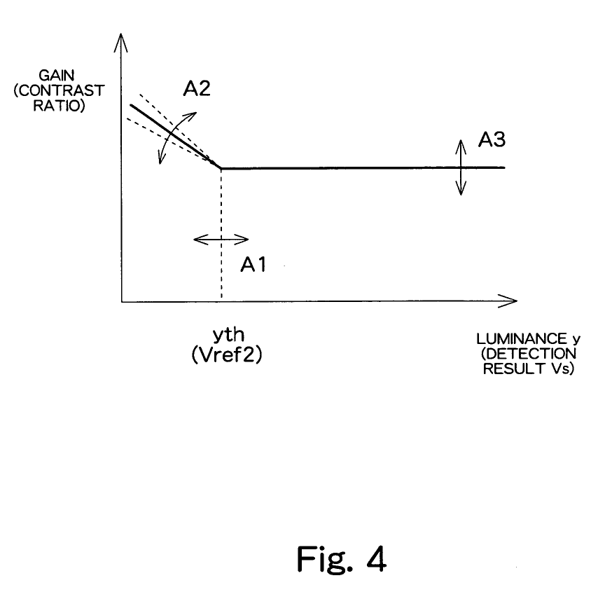

One specific example of a configuration and operation of the contrast adjustment circuit 20 is described next with reference to the attached drawings. FIG. 3 shows one example configuration of the contrast adjustment circuit 20 and FIG. 4 shows one example of a correlation between the luminance and gain (contrast ratio) in the contrast adjustment circuit 20. It should be noted that the contrast adjustment circuit 20 of FIG. 3 is configured for one chrominance signal so that in reality a similar circuit configuration to that of FIG. 3 is provided for each of the chrominance signals. It should also be noted that in FIG. 4 the abscissa shows the luminance y (luminance detection result voltage: Vs) of the video signal and the ordinate shows the gain (contrast ratio) of the amplifier 22.

As shown in FIG. 3, a contrast ratio indication signal (digital data) from an IC-BUS 30 is converted to an analog signal (voltage) V0 by a D/A converter (DAC) 24 and input by an operational amplifier (op amp) 26. The op amp 26 compares the voltage V0 of the analog signal and a voltage Vref1 of a reference signal, and outputs a gain control signal corresponding to a resulting difference. The amplifier 22 is configured so that its gain varies in accordance with the gain control signal. This type of configuration achieves the gain of amplifier 22, namely, the contrast ratio, corresponding to an indication (setting) for the contrast ratio.

It should be noted that the contrast ratio indication signal is variable according to the setting of a contrast adjustment button that is normally provided on a display device.

The voltage Vref1 of the reference signal of the op amp 26 varies in accordance with the output voltage Vs of the luminance detector circuit 18. Namely, the output voltage Vs of the luminance detector circuit 18 is input by an op amp 28, the op amp 28 compares the output voltage Vs and a voltage Vref2 of a reference signal, and outputs a voltage control signal V2 corresponding to a resulting difference. The op amp 26 is configured so that the voltage Vref1 of the reference signal varies in accordance with the voltage control signal V2. This type of configuration achieves the gain of the amplifier 22, namely, the contrast ratio, corresponding to the detection result of the luminance detector circuit 18, namely, the luminance of the video signal.

When the reference voltage Vref2 is higher than the output voltage Vs of the luminance detector circuit 18, an increase in this difference (namely, a decrease in the reference voltage Vref2) causes the output of the op amp 28, namely, voltage V2 of the voltage control signal, to increase. Furthermore, the circuit is configured so that the reference voltage Vref1 decreases as the voltage V2 of the voltage control signal increases. When the voltage V0 is higher than the reference voltage Vref1, an increase in this difference (namely, a decrease in the reference voltage Vref1) causes the output of the op amp 26, namely, the voltage of the gain control signal, to increase. This type of configuration yields a correlation between the luminance y and gain shown in FIG. 4.

Namely, in this example, in a region where the luminance (luminance detection result) y of the video signal is lower than a predetermined threshold (luminance threshold) yth with respect to the reference voltage Vref2 of the op amp 28, the gain of the amplifier 22 increases. Furthermore, the gain of the amplifier 22 increases in this region as the luminance y of the video signal decreases. That is, when the luminance is low, namely, when the video image is dark, the contrast ratio increases and the discrimination of the video image improves. Furthermore, when the luminance is high, namely, in a bright video image, the contrast ratio is lowered so as to prevent the loss of highlight detail and to enable clearer video images to be obtained for both bright and dark video images.

In the example of FIG. 4, when the luminance y of the video signal is higher than the threshold yth (or when the reference voltage Vref2 is higher than voltage V0), the contrast ratio (namely, the gain of the amplifier 22) is kept constant. However, the contrast ratio in this region can be varied as shown by an arrow A3 by the indication signal for the contrast ratio.

Furthermore, it is preferable for the reference voltage Vref2 of the op amp 28 to be variable. As a result, as shown by an arrow A1 in FIG. 4, the range for performing the contrast ratio adjustment, namely, the threshold yth, can be varied.

As an example configuration for realizing this, as shown in FIG. 3, a signal (digital signal for setting the threshold) for indicating a set value for the reference voltage Vref2 is input from IC-BUS 30 by a DAC 32 and converted into an analog signal, and this signal is input by a device (such as a transistor) for varying the reference voltage Vref2. This configuration is one example of a variable threshold mechanism. As a result, the luminance range for performing the contrast ratio adjustment can be set as desired, for example, in accordance with the operating condition or type of display.

Furthermore, it is also preferable for the gain of the op amp 28 to be variable. As a result, as shown by an arrow A2 in FIG. 4, the contrast ratio (in this case, the rate of change of the contrast ratio with respect to the luminance) corresponding to the luminance in a range for performing the contrast ratio adjustment varies. As an example configuration for realizing this, as shown in FIG. 3, a signal (digital signal for setting the contrast rate of change) for indicating a set value for a current value I2 of a constant-current supply for the op amp 28 is input from the IC-BUS 30 by a DAC 34 and converted into an analog signal, and this signal is input by a device (such as a transistor) for varying the current value I2. This is one example of a variable contrast ratio mechanism. In this manner, a more suitable contrast ratio can be obtained in the luminance range for performing the contrast ratio adjustment to match the operating condition or type of display.

An overall operation of this circuit will be briefly described here. First, the contrast ratio indication signal is determined by the original characteristics of the display apparatus or user input, and then input from an external microcomputer (microcomputer for controlling the overall display apparatus). If the reference voltage Vref1 is a constant value, the contrast ratio is determined by the contrast ratio indication signal.

On the other hand, according to the present embodiment, the reference voltage Vref1 is variable. The reference voltage Vref1 is varied by changes in the voltage control signal V2, which is the output of the op amp 28. The output of the op amp 28 is varied by the following three methods.

(i) Varying by Luminance Level

First, when the detected luminance by the luminance detector circuit 18 changes, the luminance detection result voltage Vs, which is the output of the luminance detector circuit 18, changes. The output of the op amp 28 changes in accordance with the luminance detection signal Vs.

The change in contrast ratio by the luminance detection result signal Vs is the change in the contrast ratio corresponding to the luminance at the threshold yth or lower, namely, the luminance when Vs is Vref2 or lower.

(ii) Varying by Threshold Indication Signal

The threshold indication signal may be an individual factory default setting or a user setting. Furthermore, it may be an automatic setting to take into account device aging. In FIG. 4, A1 shows an indication for setting the luminance value through a rise in contrast ratio. The reference voltage Vref2 is changed by the threshold indication signal and the luminance is changed through a rise in the contrast ratio corresponding to darkness.

(iii) Varying by Contrast Ratio Rate of Change Indication Signal

The contrast ratio indication signal indicates an amount the contrast ratio is to be raised and is the change of A2 in FIG. 4.

The amount of current of the constant-current supply driving the op amp 28 is changed by the contrast ratio rate of change indication signal. As a result, the gain of the op amp 28 changes, the voltage value that is output, with respect to the difference between the luminance detection result voltage Vs and the reference voltage Vref2, changes, and the contrast ratio rate of change with respect to darkness changes.

Although a preferred embodiment of the present invention was described hereinabove, the present invention is not intended to be limited by the above-mentioned embodiment. For example, in the above-mentioned embodiment, the gain of the amplifier for each chrominance signal was controlled by the circuit shown in FIG. 3 as a correlation of the luminance and contrast ratio as shown in FIG. 4. However, the gain of the amplifier may be controlled by another equivalent or similar circuit configuration. Furthermore, a correlation other than that given in FIG. 4 may be used. Namely, in the example of FIG. 4, although the contrast ratio was varied in a rectilinear (linear) manner when the luminance was lower than the threshold, it may instead be varied in a curvilinear or stepwise manner, or the rate of change may be varied in accordance with the luminance range. Furthermore, if the luminance is higher than the threshold (namely, in the case of a bright image), it is naturally possible to configure the circuit so as to change the suitable contrast ratio.

While there has been described what is at present considered to be the preferred embodiment of the invention, it will be understood that various modifications may be made thereto, and it is intended that the appended claims cover all such modifications as fall within the true spirit and scope of the invention.

1. A video signal processing circuit comprising:
a luminance detector for detecting a luminance of a video signal that is input; and
a contrast adjustment section for varying a contrast ratio of said video signal in accordance with detection result of said luminance detector.

2. The video signal processing circuit according to claim 1, wherein:
said contrast adjustment section is disposed for each RGB color and varies the contrast ratio for a chrominance signal for each RGB color.

3. The video signal processing circuit according to claim 1, wherein:
said video signal is a composite video signal comprising a luminance signal and a color-difference signal;
said luminance detector detects the luminance of the luminance signal;
said contrast adjustment section generates a chrominance signal for each RGB color from said color-difference signal and said luminance signal, and varies the contrast ratio for the respective chrominance signal that was obtained for each RGB color.

4. The video signal processing circuit according to claim 1, wherein:
said contrast adjustment section performs contrast ratio adjustment so that the lower the luminance, which is detected by said luminance detector, the higher the contrast ratio is raised.

5. The video signal processing circuit according to claim 4, wherein:
said contrast adjustment section performs contrast ratio adjustment in accordance with the luminance only when the luminance, which is detected by said luminance detector, is lower than a predetermined threshold.

6. The video signal processing circuit according to claim 5, wherein:
said contrast adjustment section for each color comprises, for said color signal for each RGB color, an op amp for inputting a luminance detection result voltage that indicates the luminance detected by said luminance detector and a reference voltage that corresponds to said threshold; and
varies the contrast ratio by varying the amplification factor for said color signal for each RGB color according to an output of the op amp.

7. The video signal processing circuit according to claim 6, comprising:
a variable threshold circuit for variably setting said threshold.

8. The video signal processing circuit according to claim 7, wherein:
said variable threshold circuit varies the reference voltage that corresponds to said threshold in accordance with a threshold indication signal.

9. The video signal processing circuit according to claim 6, comprising:
a variable contrast ratio circuit for variably setting the contrast ratio that corresponds to the luminance.

10. The video signal processing circuit according to claim 9, wherein:
said variable contrast ratio circuit varies the gain of an op amp in accordance with a contrast ratio rate of change indication signal.

11. The video signal processing circuit according to claim 10, wherein:
said variable contrast ratio circuit varies the gain of said op amp by varying a current value of a constant-current supply that supplies operating current to said op amp.
